(19) United States
(12) Patent Application Publication
(10) Pub. No.: US 2024/0112463 A1
(43) Pub. Date: Apr. 4, 2024

(54) DETECTION OF OBJECT STRUCTURAL STATUS

(71) Applicant: Amazon Technologies, Inc., Seattle, WA (US)

(72) Inventors: Lee Gondorchin, Spring, TX (US); Daniel Scott Kahn, Houston, TX (US); Nick E. Loeffler, Mercer Island, WA (US)

(21) Appl. No.: 17/957,154

(22) Filed: Sep. 30, 2022

(51) Int. Cl. G06V 20/10; G06T 7/00; G06T 7/292; G06T 7/593; G06V 10/764; G06V 10/774; G06V 20/17

(52) U.S. Cl. CPC G06V 20/188; G06T 7/0012; G06T 7/292; G06T 7/593; G06V 10/764; G06V 10/774; G06V 20/17; G06T 2207/10012; G06T 2207/10028; G06T 2207/30004; G06T 2207/30188

(57) ABSTRACT

Systems and techniques are disclosed for predicting the structural status of an object. An object model, such as a machine learning model, can be trained on sample sensor data indicating vibrations, movements, and/or other reactions of objects with known desired and undesired structural statuses to a stimulus agent, such as a puff of air. A scanning device can output a corresponding stimulus agent towards an object, capture sensor data indicating the reaction of the object to the stimulus agent, and provide the sensor data to the trained object model. Based on the sensor data indicating how the object reacted to the stimulus agent, the object model can predict whether the object has a desired structural status or an undesired structural status.

### BACKGROUND

In some situations, structures of objects can deteriorate or become compromised. As an example, produce may become compromised due to mold, fungus, pests, disease, and/or other issues. As another example, components of buildings or other structures may deteriorate over time due to age and/or other issues.

Some structural issues with objects may be immediately apparent to observers based on the exterior of the objects, for instance if the exterior of an object appears damaged or broken. However, other structural issues can exist within the interiors of objects, and thus may not be immediately apparent to observers based on the exteriors of the objects. For example, if powdery mildew caused by fungus has compromised the interior structure of a grape, the grape may nevertheless appear to be healthy to an observer who views the exterior of the grape.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 shows an example of an object scanning system that can predict a structural status of an object.

FIG. 2 shows an example of a mobile instance of a scanning device of the object scanning system.

FIG. 3 shows an example of a handheld instance of the scanning device of the object scanning system.

FIG. 4 shows an example of a stationary instance of the scanning device of the object scanning system.

FIG. 5 is a flow diagram of an illustrative process by which the object scanning system can predict the structural status of the object.

FIG. 6 is a system and network diagram that shows an illustrative operating environment for configurations disclosed herein.

FIG. 7 is a computing system diagram that illustrates one configuration for a data center that can be utilized to implement an object model and/or other elements of the object scanning system.

FIG. 8 is a system services diagram that shows aspects of several services that can be provided by and utilized within a service provider network, which can be configured to implement various technologies disclosed herein.

FIG. 9 shows an example computer architecture for a computer capable of executing program components for implementing functionality described herein.

### DETAILED DESCRIPTION

Entities may desire to determine the structural status of an object, and/or structural statuses of multiple objects. For example, entities who grow, harvest, and/or sell pieces of produce may want to determine the structural statuses of individual pieces of produce, because such structural statuses can indicate which pieces of produce are healthy and/or are in conditions suitable for consumers, and which pieces of produce are unhealthy, spoiled, and/or otherwise are not in conditions suitable for consumers. Some issues with the structure of an object may be apparent to an observer based on the appearance of the exterior of the object, such as if the exterior of the object is damaged. However, other issues that impact the structure of an object may not be apparent to an observer based on the appearance of the exterior of the object. It can accordingly be difficult to determine the structural status of an object based only on the external appearance of the object.

For instance, mold, fungus, diseases, pests, and/or other issues may break down internal structures of produce, such that the produce becomes spoiled or rotten. However, such structural issues may not impact shapes, colors, and/or other attributes of the exterior appearance of the produce, such that it can be difficult to determine that such structural issues exist just by looking at the exterior of the produce. As an example, if a human inspector views a set of grapes at a vineyard, it can be difficult for the human inspector to visually determine which of the grapes, if any, are compromised by powdery mildew, disease, pests, or other issues that may impact the interior structures of the grapes but that do not impact the exteriors of the grapes.

In some situations, tests can be performed to determine the structural statuses of objects. However, such tests can take significant amounts of time and effort, particularly when there are numerous objects to be tested. For example, a human inspector at a vineyard may squeeze individual grapes to determine which are ripe and have internal structures that are relatively resistant to being squeezed, and which have internal structural issues that allow the grapes to be squeezed to a greater degree. However, performing such manual squeeze tests on a large set of grapes growing at a vineyard may take a significant amount of time and effort.

However, described herein is an object scanning system that can predict a structural status of an object. The object scanning system can introduce a stimulus agent to the object, for instance by blowing a puff of air at the object, and can use cameras and/or other sensors to determine how the object reacts to the stimulus agent. The object scanning system can also use a machine learning model to predict, based on sensor data indicating how the object reacts to the stimulus agent, the structural status of the object. For example, a healthy grape and an unhealthy grape that is impacted by internal structural issues may vibrate, move, deform, and/or otherwise react differently in response to being impacted by equivalent puffs of air, such that how a grape reacts to an equivalent puff of air can indicate whether the grape is healthy or unhealthy. Accordingly, the object scanning system can use the machine learning model to determine whether an object reacts to a stimulus agent with a response that consistent with a desired structural status, or whether the object reacts to the stimulus with a different response that is not associated with the desired structural status.

The systems and methods associated with the object scanning system described herein may be implemented in a number of ways. Example implementations are provided below with reference to the following figures.

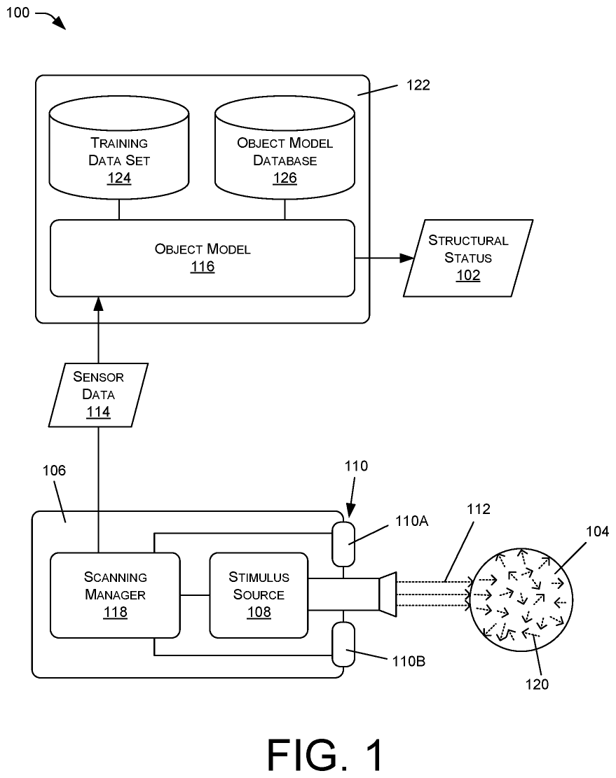

FIG. 1 shows an example of an object scanning system 100 that can predict a structural status 102 of an object 104. The object scanning system 100 can include a scanning device 106 that has a stimulus source 108 and sensors 110, The stimulus source 108 can be configured to output a stimulus agent 112 that can impact the object 104, and thereby cause a reaction on the exterior of the object 104 and/or within the interior of the object 104. For example, as described further below, the stimulus source 108 can propel a puff of air at the object 104 to induce a reaction of the object 104, such as external and/or internal vibrations, wave movements, deformations, and/or other movements of the object 104. The sensors 110 of the scanning device 106 can capture sensor data 114, such as stereoscopic images, that indicate the reaction of the object 104 to the stimulus agent 112. For example, disparities between stereoscopic images can indicate three-dimensional motions of the entire object 104 and/or portions of the object 104, such as vibrations, wave movements, deformations, and/or other types of movements, in response to the stimulus agent 112.

The object scanning system 100 can also have an object model 116, such as a machine learning model that has been trained to predict structural statuses of objects. Accordingly, the object scanning system 100 can use the object model 116 to predict the structural status 102 of the object 104, based on the sensor data 114 that indicates the reaction of the object 104 to the stimulus agent 112. The structural status 102 can, for example, be a desired structural status or an undesired structural status. A desired structural status can be associated with a normal instance of the object 104 that has a normal, expected, and/or desired internal structure, while an undesired structural status can be associated with an abnormal instance of the object 104 that has an abnormal, unexpected, and/or undesired internal structure. For example, even if the exterior of the object 104 appears normal to a human observer, the structural status 102 predicted by the object model 116 based on the sensor data 114 may indicate that the internal structure of the object 104 is likely to be abnormal, unexpected, and/or undesired.

The object 104 can be any type of physical item, such as a piece of produce, a physical product, a component of a building or other structure, or any other type of item. As an example, the object 104 can be a grape, an orange, a watermelon, or other piece of produce. Such produce may still be growing on a farm or other location. For instance, if the object 104 is a grape, the grape may still be on a vine at a vineyard. As another example, the object 104 can be a piece of produce that has been picked or harvested, a product, a product component, or another type of item that is stationary or in transit within a factory, warehouse, or other industrial or commercial setting. For instance, the object 104 can be a product being transported along a conveyor belt. As yet another example, the object 104 can be a component of a building or other structure, such as an underwater concrete support element for a pier or a structural component of a building.

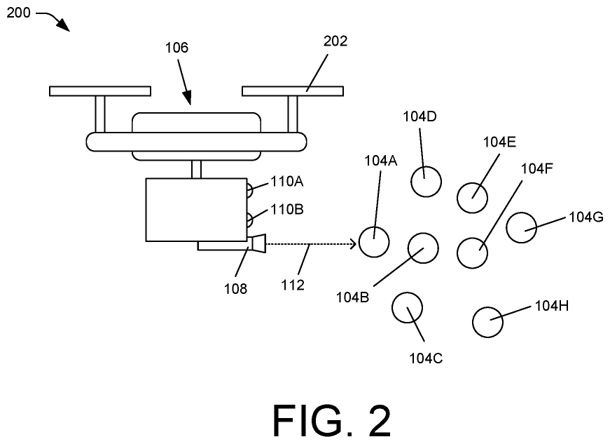

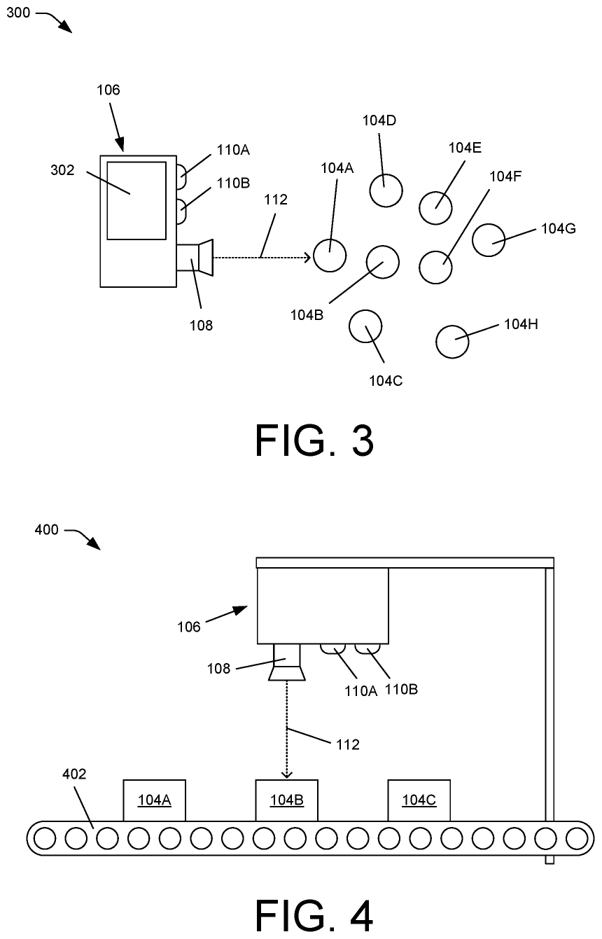

The scanning device 106 can be part of, or be mounted on, a stationary or mobile device. For example, the scanning device 106 may be part of a drone, such as an unmanned aerial vehicle (UAV), or other aerial device or vehicle that can fly near, and/or hover by, the object 104, for instance as discussed further below with respect to FIG. 2. As another example, the scanning device 106 can be part of a robot, vehicle, or other device that can roll, walk, or otherwise move to and/or by the object 104. As yet another example, the scanning device 106 may be a handheld device that a user can hold up near the object 104, for instance as discussed further below with respect to FIG. 3. As still another example, the scanning device 106 may be mounted in a stationary position, such as above or beside a conveyer belt that transports the object 104 and other objects past the scanning device 106, for instance as discussed further below with respect to FIG. 4.

The scanning device 106 can have a scanning manager 118, such as software or firmware, that is configured to control operations of the scanning device 106. For example, the scanning manager 118 can be configured to control how and/or when the stimulus source 108 outputs the stimulus agent 112, for instance by indicating speeds, pressures, and/or amounts of the stimulus agent 112 that are to be output by the stimulus source 108. As another example, the scanning manager 118 can be configured to control how and/or when the sensors 110 capture the sensor data 114.

As discussed above, the stimulus source 108 of the scanning device 106 can output the stimulus agent 112 to induce a reaction of the object 104. The stimulus agent 112 can include one or more types of matter, such as one or more gases, liquids, or solids.

As an example, the stimulus agent 112 can be air. In this example, the stimulus source 108 can include a container of pressurized air and a nozzle that can output one or more controlled puffs of air toward the object 104. For instance, the stimulus agent 112 can be a predetermined amount of air, or an amount of air determined by the scanning manager 118. In some examples, the stimulus source 108 can output an amount of air towards the object 104 based on target pressures, speeds, and/or other variables determined by the scanning manager 118.

As another example, the stimulus agent 112 may be water, and the stimulus source 108 can output controlled jets of water towards the object 104. For instance, if the object 104 is located underwater, the stimulus source 108 can propel one or more jets of water through a surrounding water environment towards the object 104.

When the stimulus source 108 outputs the stimulus agent 112, and the stimulus agent 112 impacts the object 104, one or more portions of the object 104 can vibrate, move, indent, deform, and/or otherwise react to the stimulus agent 112. As an example, when a puff of air or another stimulus agent 112 impacts the object 104, the impact of the stimulus agent 112 on the object 104 can cause forces to propagate though the object 104 that may result in movements of exterior and/or interior portions of the object 104.

The impact of the stimulus agent 112 on the object 104 can, for instance, cause vibrations of one or more portions of the object 104, and/or cause waves 120 to propagate though the object 104. Such waves 120 may be reflected, refracted, and/or otherwise impacted in one or more ways by external aid/or internal structural elements of the object 104, and thereby cause or influence corresponding movements of one or more exterior portions of the object 104. As described further below, such movements of the object 104 in reaction to the stimulus agent 112 can be indicated by sensor data 114 captured by the sensors 110 of the scanning device 106.

As a first example, if the object 104 is a grape, internal cellular walls of the grape may reflect and/or refract waves 120 propagating though the object 104, such that the waves 120 may propagate in different directions throughout different portions of the grape based on the presence and/or structural integrity of such internal cellular walls. Accordingly, portions of the exterior of the grape may vibrate differently, and/or exhibit other different types of movements, based on how the internal structure of the grape influences the direction, speed, frequency, and/or other attributes of waves 120 propagating through the grape. For instance, if equivalent puffs of air are blown at a first grape that is ripe and relatively solid, and at a second grape that is old, unhealthy, and/or mushy and is less solid than the first grape, waves 120 induced by the equivalent puffs of air may propagate differently through the first grape and the second grape and cause different external vibrations and/or other movements of the first grape and the second grape.

As another example, if the object 104 is a concrete structure, waves 120 induced by an impact of the stimulus agent 112 on the object 104 may propagate through the object 104 differently depending on the age and/or structural condition of internal portions of the concrete structure. Accordingly, overall vibrations and/or other movements of portions of the exterior of the concrete structure may differ based on such conditions of the internal portions of the concrete structure that influence how waves 120 propagate through the concrete structure.

Because such movements of the object 104 in response to the stimulus agent 112 can be indicative of the structural status 102 of the object 104, the scanning manager 118 can cause the sensors 110 of the scanning device to capture sensor data 114 that indicates the reaction of the object 104 to the stimulus agent 112. The scanning manager 118 can, for example, instruct the stimulus source 108 to output the stimulus agent 112 towards the object 104, and also instruct one or more sensors 110 to capture corresponding sensor data 114 that indicates the reaction of the object 104 to the stimulus agent 112.

The sensors 110 of the scanning device 106 can include cameras, Light Detection and Ranging (LiDAR) sensors, interferometry sensors, distance sensors, proximity sensors, geospatial sensors such as Global Positioning System (GPS) sensors or other positioning sensors, and/or other types of sensors. In some examples, the sensors 110 can capture one or more types of sensor data 114 that indicate a reaction of the object 104 to the stimulus agent 112. In other examples, the same sensors 110 and/or different sensors 110 can be used to position the scanning device 106 relative to the object 104 prior to the stimulus source 108 outputting the stimulus agent 112, to determine when the stimulus source 108 is to output the stimulus agent 112, and/or for other purposes as described further below.

The sensors 110 can include cameras configured to capture images and/or other types of sensor data 114 based on the visible light spectrum, the infrared light spectrum, and/or other portions of the electromagnetic spectrum. In some examples, different cameras can be configured to capture sensor data 114 based on different portions of the electromagnetic spectrum. For instance, the scanning device 106 can have one or more visible light cameras, and also have one or more infrared cameras.

In some examples, the sensors 110 can include at least two cameras spaced apart by a distance on the scanning device 106, such as sensor 110A and sensor 110B shown in FIG. 1. Such cameras that are spaced apart can be configured to capture stereoscopic images of the object 104. The cameras can also be configured to capture successive images, or successive sets of stereoscopic images, at framerates that can indicate vibrations, waves, and/or other movements of the object 104 in response to the stimulus agent 112. For example, the scanning manager 118 can set the framerate of the cameras based on frequencies associated with vibrations, wave movements, and/or other types of movements on and/or within the object 104 that are expected, based on training of the object model 116 as described further below, to be induced by the stimulus agent 112.

In other examples, different types of sensors can be used to capture sensor data 114 associated with a reaction of the object 104 to the stimulus agent 112 instead of, or in addition, to cameras. As an example, if the object 104 is underwater and the stimulus agent 112 and/or surrounding environmental water may diffract light and thus distort images captured by cameras, the scanning device 106 can be configured to also, or alternately, use one or more LiDAR sensors to capture sensor data 114 indicating depth information associated with the object 104. For instance, such LiDAR sensors can capture depth information over a period of time that indicates how the object 104 reacts to the stimulus agent 112. As another example, the sensors 110 can include speckle interferometry sensors that can shine lasers at the object 104 to cover a portion of the exterior surface of the object 104 with a pattern of dots, such that sensor data 114 captured by cameras or other sensors 110 can indicate movements of individual dots on the surface of the object 104 as the object 104 vibrates, deforms, and/or otherwise moves in reaction to the stimulus agent 112.

The cameras and/or other sensors 110 of the scanning device 106 can have a framerate, resolution, and/or other attributes that allow the sensor data 114 to indicate vibrations, wave movements, and/or other reactions of the object 104 to the stimulus agent 112. In some examples, such vibrations or other movements of the object 104 may be relatively small, but the sensors 110 can be configured to capture sensor data 114 that indicates such small movements, for instance via a relatively high image capture resolution and/or at a relatively high framerate.

In some examples, the scanning manager 118 can process sensor data 114 captured by sensors 110 to determine the reaction of the object 104 to the stimulus agent 112. For example, disparities between stereoscopic images captured by sensor 110A and sensor 110B can indicate traces of external and/or internal movements of the object 104. Accordingly, the scanning manager 118 can process such stereoscopic images to identify and/or measure the disparities that indicate the reaction of the object 104 to the stimulus agent 112. In these examples, the scanning manager 118 can send new or derived sensor data 114, indicating the reaction of the object 104 to the stimulus agent 112 determined by the scanning manager 118 based on the originally-captured sensor data 114, to the object model 116 in addition to, or instead of, the originally-captured sensor data 114. In other examples, the scanning manager 118 can send the originally-captured sensor data 114 to the object model 116, and the object model 116 or another associated element can similarly process the originally-captured sensor data 114 to determine the reaction of the object 104 to the stimulus agent 112.

The object model 116 can execute via one or more computing resources 122. The computing resources 122 can include, or be associated with, local computing devices, edge computing devices, remote servers, virtual computing resources, such as containers and/or virtual machines, and/or other types of computing resources.

In some examples, the computing resources 122 can be part, of the scanning device 106. For instance, the computing resources 122 can include one or more processors, memory, and/or other computing elements of the scanning device 106, such that the object model 116 can execute locally at the scanning device 106 as part of the scanning manager 118 or as a separate element.

In other examples, the computing resources 122 can be separate from the scanning device 106. For instance, the computing resources 122 can be associated with an edge computing device, a cloud computing environment, or other computing environment that is separate from and/or remote from the scanning device 106. In these examples, the scanning device 106 can have wired and/or wireless data interfaces, such as cellular data interfaces, Ethernet data interfaces, and/or other data interfaces, such that the scanning manager 118 can send originally-captured and/or processed sensor data 114 over the Internet and/or other networks to the object model 116 executing on one or more separate aid/or remote computing resources 122. As a first example, the computing resources 122 can be associated with a cloud computing environment, such as a service provider network, that the scanning manager 118 can access via the Internet. As a second example, the computing resources 122 can be associated with an edge computing device, such as a local computing device that may be on-site in the same environment as the scanning device 106, or a server on a local network or at another network position that may be closer to the scanning device 106 than a cloud computing environment.

As described above, the object model 116 can use the sensor data 114, indicating the reaction of the object 104 to the stimulus agent 112, to predict the structural status 102 of the object 104. The object model 116 can be a machine learning model, such as a machine learning model based on convolutional neural networks, recurrent neural networks, other types of neural networks, nearest-neighbor algorithms, regression analysis, deep learning algorithms, Gradient Boosted Machines (GBMs), Random Forest algorithms, and/or other types of artificial intelligence or machine learning frameworks.

The object model 116 can be trained, via supervised machine learning techniques, on a training data set 124. The training data set 124 can include instances of sensor data 114 captured in association with reactions of other objects, similar to the object 104 and/or of the same type or classification as the object 104, to instances of the stimulus agent 112. The training data set 124 can be labeled to indicate whether individual instances of sensor data 114 in the training data set 124 correspond to reactions of first objects that were known to have desired structural statuses, or correspond to reactions of second objects that were known to have undesired structural statuses. For example, if the object 104 is a grape and the stimulus agent 112 is air, the training data set 124 can include labeled sensor data 114 indicating reactions of known healthy grapes and known unhealthy grapes to puffs of air. Via supervised machine learning techniques, the object model 116 can be trained to identify features of instances of sensor data 114 in the training data set 124, such as patterns, movements, disparities, and/or other features shown in sample images of reactions of objects, that are predictive of the reactions of the first objects with desired structural statuses and/or the reactions of the second objects with undesired structural statuses.

Accordingly, the object model 116 can be trained, based on the training data set 124, to serve as a digital twin of an instance of the object 104 that has the desired structural status. When the scanning device 106 captures new sensor data 114 associated with the object 104 as described above, the trained object model 116 can use features indicated in the sensor data 114, such as patterns, movements, disparities, and/or other features shown in images of the sensor data 114, to determine whether the reaction of the object 104 to the stimulus agent 112 is consistent with how the object 104 should react if the object 104 has the desired structural status.

For example, as discussed above, the sensor data 114 captured by the scanning device 106 can include a sequence of stereoscopic images from which disparities, indicative of movements of waves 120 through the object 104 and/or other movements of the object 104 in response to the stimulus agent 112, can be determined. The object model 116 can be trained to predict, based on such disparities indicated by the sensor data 114, whether the object 104 has the desired structural status or has an undesired structural status. The object model 116 can accordingly predict, based on the sensor data 114, the structural status 102 to indicate whether the object 104 likely has the desired structural status or likely has an undesired structural status.

In some examples, the training data set 124 can be labeled to indicate known reasons why objects were known to have undesired structural statuses. Accordingly, the object model 116 can be trained to predict a reason why the object 104 may have an undesired structural status if the object model 116 determines that the object 104 likely does not have the desired structural status.

As an example, if the object 104 is a grape, the training data set 124 can include labeled sensor data 114 associated with reactions of known healthy grapes and known unhealthy grapes to the stimulus agent 112, and that also indicates that a first set of unhealthy grapes were known to be infected with powdery mildew and a second set of specific unhealthy grapes were known to be infected with a type of pest. The object model 116 can thus be trained to predict, from such labeled sensor data 114 in the training data set 124, the specific reasons why individual unhealthy grapes were unhealthy. Accordingly, when the trained object model 116 processes new sensor data 114 indicating a reaction of a newly-scanned grape to the stimulus agent 112, and determines that the reaction of the newly-scanned grape is not consistent with a healthy grape, the object model 116 can use the sensor data 114 to predict that the grape is likely to be unhealthy and to also predict a likely reason why the grape is unhealthy. For instance, if the sensor data 114 indicates that the reaction of the grape to the stimulus agent 112 is consistent with reactions of grapes that were known to be infected with powdery mildew, the structural status 102 predicted by the object model 116 can indicate that the grape is likely unhealthy due to powdery mildew.

As discussed above, the scanning manager 118 can control the speed, pressure, and/or other variables associated with how the stimulus source 108 outputs the stimulus agent 112 towards the object 104. In some examples, the scanning manager 118 can control such speeds, pressures, and/or other variables based on values of the variables indicated in the training data set 124. For example, if the training data set 124 includes sample instances of sensor data 114 captured after sample objects were impacted by puffs of air blown at a particular speed, at a particular pressure, and/or from a particular distance indicated in the training data set 124, the scanning manager 118 can cause the stimulus source 108 of the scanning device 106 to output an equivalent puff of air toward the object 104 at the particular speed, at the particular pressure, and/or from the particular distance. Accordingly, the reaction of the object 104 to the stimulus agent 112, indicated by the sensor data 114 provided to the object model 116, can be induced under the same or similar conditions as reactions of other objects indicated by the training data set 124 used to train the object model 116.

In some examples, the scanning manager 118 can cause the stimulus source 108 to output the stimulus agent 112 towards the object 104 multiple times, for instance to vary the speeds, pressures, and/or values of other variables defining how the stimulus source 108 outputs the stimulus agent 112 towards the object 104. The scanning manager 118 can also cause the sensors 110 to capture corresponding sensor data 114 associated with the different outputs of the stimulus agent 112 towards the object 104, such that the sensor data 114 indicates different reactions of the object 104 to the different outputs of the stimulus agent 112 towards the object 104 based on different values of variables. As an example, the scanning manager 118 can be configured to cause the stimulus source 108 to output the stimulus agent 112 towards the object 104 three times at different speeds, such that three sets of corresponding sensor data 114 can indicate different reactions of the object 104 to the three different outputs of the stimulus agent 112.

The object model 116 can similarly have been trained based on reactions of objects to stimulus agents output based on different values of variables. Accordingly, if the object model 116 is unable to predict the structural status 102 of the object 104 based on one set of sensor data 114, the object model 116 may be able to predict the structural status 102 of the object 104 based on one or more other sets of sensor data 114. For instance, if the reaction of the object 104 to a puff of air blown at a low speed does not indicate whether the object 104 has a desired structural status, but other reactions of the object 104 to puffs of air blown at higher speeds do indicate whether the object 104 has a desired structural status, the object model 116 can predict the structural status 102 based on the sets of sensor data 114 that correspond to the higher-speed puffs of air. Similarly, the object model 116 may increase a confidence level of the prediction of the structural status 102 if multiple sets of sensor data 114, corresponding to different outputs of the stimulus agent 112 based on different values of variables, each indicate that the object 104 has the desired structural status or does not have the desired structural status.

In some examples, the object scanning system 100 can include an object model database 126 that includes object models associated with different types of objects and/or different classifications of objects. As an example, the object model database 126 can include a first object model associated with grapes, a second object model associated with watermelons, a third object model associated with a type of concrete support structure, and/or any other object models associated with any other type of object. As another example, the object model database 126 can include multiple distinct object models associated with different species of grapes, different ages of grapes, and/or other types of classifications.

Each object model in the object model database 126 can be a separate model that is trained based on a distinct training data set associated with a corresponding object type and/or classification. As an example, because internal structures of grapes can change as the grapes grow and mature, grapes different ages may be expected to have different reactions to equivalent puffs of air. Accordingly, a first object model associated with young grapes within a first age range can be trained on a first training data set that indicates reactions of known healthy and unhealthy grapes in the first age range to puffs of air, while a second object model associated with older grapes within a second age range can be trained on a separate second training data set that indicates reactions of known healthy and unhealthy grapes in the second age range to puffs of air.

Accordingly, in some examples, the object model 116 that corresponds to the type and/or classification of the object 104 can be identified in the object model database 126, such that the corresponding object model 116 can be used to predict the structural status 102 of the object 104. As an example, if the scanning device 106 is a handheld device that could be used to analyze any type of object, the scanning device 106 may accept user input indicating a type and/or classification of the object 104, such that the scanning manager 118 and/or the computing resources 122 can use the user input to determine which object model in the object model database 126 to use to predict the structural status 102 of the object 104. As another example, if sensors 110 of the scanning device 106 capture images of the object 104, the scanning manager 118 and/or the computing resources 122 can be configured to use image analysis and/or object recognition techniques to identify the type and/or classification of the object 104 shown in the images, and thereby determine which object model in the object model database 126 to use to predict the structural status 102 of the object 104. As still another example, if the scanning device 106 is deployed to an environment in which a particular type and/or classification of object is expected to be present, an instance of the corresponding object model from the object model database can be retrieved from the object model database 126 and be loaded onto the scanning device 106 for local execution during that deployment, or remote computing resources 122 in an edge computing device or a cloud computing environment can be configured to use the corresponding object model when processing sensor data 114 received from the scanning device 106 in association with that deployment.

In still other examples, the computing resources 122 may process sensor data 114 with multiple object models in the object model database 126. For instance, if the type and/or classification of the object 104 is not known, the computing resources 122 may process the sensor data 114 and determine how closely the reaction of the object 104 to the stimulus agent 112 corresponds with reactions of different types and/or classifications of objects with desired and/or undesired structural statuses. As an example, the computing resources 122 may process the same sensor data 114 using a first object model associated with relatively young grapes and a second object model associated with older grapes, and determine with a 90% confidence level that the reaction of object 104 indicated the sensor data 114 is consistent with a healthy young grape, and determine with a 40% confidence level that the reaction of object 104 indicated the sensor data 114 is consistent with a healthy older grape. Accordingly, based on the higher confidence level, the computing resources 122 may determine that the object is most likely to be a young grape, and output the corresponding structural status prediction indicating that the object 104 is a healthy young grape.

As discussed above, the object model 116 can be trained on the corresponding training data set 124. In some examples, first computing resources 122 can be used to train the object model 116 on the training data set 124, while second computing resources 122 can be used to execute a trained instance of the object model 116. For instance, if the object model 116 executes locally on computing resources 122 of the scanning device 106 to process sensor data 114 captured by sensors HO of the scanning device, the object model 116 may be initially trained on a remote server or other separate computing resources using the training data set 124. After such training of the object model 116, a trained instance of the object model 116 can be loaded onto the computing resources 122 of the scanning device 106 for local execution based on new sensor data 114 captured by sensors 110 of the scanning device 106.

As discussed above, images and/or other types of sensor data 114 captured by one or more types of sensors 110 of the scanning device 106 can indicate a reaction of the object 104 to the stimulus agent 112, and can be used by the object model 116 to predict the structural status 102 of the object 104. However, sensor data 114 captured by the same sensors 110 and/or different sensors 110 can be used to position the scanning device 106 relative to the object 104 prior to the stimulus source 108 outputting the stimulus agent 112, to determine when the stimulus source 108 is to output the stimulus agent 112, and/or for other purposes.

For example, the scanning manager 118 can use sensor data 114 captured by one or more sensors 110 to determine when the stimulus source 108 is at a target distance away from the object 104, and/or how to move the scanning device 106 to a position that is at the target distance away from the object 104. The target distance can be a predefined distance at which the stimulus source 108 is to output the stimulus agent 112 toward the object 104, and may correspond to distances indicated in the training data set 124 from which instances of the stimulus agent 112 were output toward sample objects during collection of the training data set 124 as discussed above. As an example, if the target distance is six inches, the scanning manager 118 can use sensor data 114 captured by one or more laser distance sensors, or other proximity or distance sensors, of the scanning device 106 to determine when the scanning device 106 is six inches away from the object 104, or whether the scanning device 106 should move closer to or farther away from the object 104 to bring the scanning device 106 six inches away from the object 104.

In some examples, if sensor data 114 captured by a distance sensor indicates that the scanning device 106 is at a position that is the target distance away from the object 104, the scanning manager 118 can instruct the stimulus source 108 to automatically output the stimulus agent 112, and also instruct one or more sensors 110 to automatically capture sensor data 114 indicating the reaction of the object 104 to the stimulus agent 112. In other examples, if sensor data 114 captured by a distance sensor indicates that the scanning device 106 is at a position that is the target distance away from the object 104, the scanning manager 118 can enable a user interface option or other user control that can be selected by a user to initiate an output of the stimulus agent 112 and corresponding capture of the sensor data 114 indicating the reaction of the object 104 to the stimulus agent 112.

In some examples, if sensor data 114 captured by a distance sensor instead indicates that the scanning device 106 is not at a position that is the target distance away from the object 104, the scanning manager 118 can cause autonomous movement of the scanning device 106 to a position that is the target distance away from the object 104. For instance, if the scanning device 106 is part of an autonomous mobile device that is configured to move automatically, such as a drone as shown in FIG. 2, the scanning manager 118 can instruct propulsion and/or guidance systems of the autonomous mobile device to move the scanning device 106 in one or more directions until sensor data 114 indicates that the scanning device 106 is at a position that is the target distance away from the object 104. When the sensor data 114 indicates that the scanning device 106 has moved to a position that is the target distance away from the object 104, the scanning manager 118 can initiate output of the stimulus agent 112 and capture of other sensor data 114 indicating the reaction of the object 104 to the stimulus agent 112 as described above.

In other examples, if sensor data 114 captured by a distance sensor indicates that the scanning device 106 is not at a position that is the target distance away from the object 104, the scanning manager 118 can recommend movements of the scanning device 106 or the object 104 that would bring the scanning device 106 to a position that is the target distance away from the object 104. For instance, if the scanning device 106 is a handheld device operated by a user as shown in FIG. 3, the scanning manager 118 can present recommendations via a user interface of the scanning device 106 that guide the user to move the scanning device 106 in one or more directions until sensor data 114 captured by a distance sensor indicates that the scanning device 106 is at a position that is the target distance away from the object 104. When the user moves the scanning device 106 and sensor data 114 indicates that the scanning device 106 has been moved to a position that is the target distance away from the object 104, the scanning manager 118 can automatically initiate output of the stimulus agent 112 and capture of other sensor data 114 indicating the reaction of the object 104 to the stimulus agent 112, or enable user-selectable options that the user can select to initiate output of the stimulus agent 112 and capture of corresponding sensor data 114 indicating the reaction of the object 104.

In still other examples, if sensor data 114 captured by a distance sensor indicates that the scanning device 106 is not at a position that is the target distance away from the object 104, the scanning manager 118 can adjust variables associated without output of the stimulus agent 112 towards the object 104, to compensate for the scanning device 106 being too close or too far away from the object 104. For example, if the target distance is six inches, but sensor data 114 indicates that the scanning device 106 is twelve inches away from the object 104, the scanning manager 118 can cause the stimulus source 108 to output the stimulus agent 112 at a higher speed and/or higher pressure than would be used from a distance of six inches away. In this example, the higher speed and/or higher pressure can cause the stimulus agent 112 to induce a reaction of the object 104 from a distance of twelve inches away equivalently to how the stimulus agent 112 would induce a reaction of the object 104 from a distance of six inches away using a lower speed and/or lower pressure.

As described above, the object model 116 can use sensor data 114, indicating the reaction of the object 104 to the stimulus agent 112, to predict the structural status 102 of the object 104. The object model 116 can output the predicted structural status 102 to one or more destinations, and/or cause a display of the predicted structural status 102 via a user interface.

As an example, if the scanning device 106 is a handheld device operated by a user, the object model 116 can cause the predicted structural status 102 to be displayed via a user interface on a screen of the handheld device, via one or more lights of the handheld device, via one or more speakers of the handheld device, and/or via any other user-perceptible element of the handheld device. For instance, if the object model 116 determines that the object 104 is likely to have a desired structural status, a user interface displayed on a screen of the handheld device can display a corresponding message indicating that the object 104 likely has the desired structural status, and/or a green light may illuminate on the handheld device. However, if the object model 116 instead determines that the object 104 is not likely to have the desired structural status, the user interface displayed on the screen of the handheld device can display a corresponding message indicating that the object 104 likely does not have the desired structural status, and/or a red light may illuminate on the handheld device. In some examples, a message displayed on the screen of the handheld device may also, or alternately, indicate a predicted reason why the object 104 likely does not have the desired structural status, for instance if the object model 116 has been trained to predict such reasons.

As another example, if the scanning device 106 is a drone or other autonomous mobile device, the object model 116 may output the structural status 102 associated with the object 104 in a report that is stored on a server or other storage location, is displayed via a user interface displayed via one or more computing devices, is sent to one or more email addresses, and/or is otherwise provided to one or more destinations. In some examples, such a report can indicate the structural status 102 associated with the object 104 along with geospatial coordinates, timestamps, and/or data indicating when and/or where the scanning device 106 and the object 104 was located when the sensor data 114 indicating the reaction of the object 104 to the stimulus agent 112 was captured. Accordingly, if the structural status 102 is not presented in real-time, the report can indicate location data and/or other data that indicates which object is associated with that structural status 102.

For instance, when the scanning device 106 moves to a position near the object 104, outputs the stimulus agent 112, and collects corresponding sensor data 114, the scanning manager 118 can log GPS coordinates and/or other geospatial information indicating the position of the scanning device 106 and/or the object 104, and one or more timestamps indicating when the stimulus agent 112 agent was output and when sensor data 114 was collected. The scanning manager 118 can provide such geospatial information, timestamps, and/or other data to the object model 116 in or alongside the sensor data 114, such that the object model 116 can indicate a time, location, and/or other information associated with the structural status 102 predicted based on the sensor data 114. Accordingly, if the scanning device 106 moves through an environment to scan multiple objects at different times and/or positions, the object model 116 can predict structural statuses of multiple objects. A report generated by the object model 116 can indicate geospatial coordinates, times, and/or other data associated with each of the structural statuses, such that a user or other entity can determine which structural status corresponds with which object.

For example, if the scanning device 106 is a drone at a vineyard that is tasked to autonomously scan multiple grapes, the scanning device 106 can use a grid pattern to successively scan a series of grapes within different grid segments at the vineyard, scan randomly-selected grapes at the vineyard, and/or otherwise scan different grapes at different locations at the vineyard. The scanning manager 118 can track GPS coordinates and/or other geospatial information associated with the location of each scanned grape, and provide that data to the object model 116. The object model 116 may thus produce a report indicating that a first grape at first coordinates is predicted to have a desired structural status, but that a second grape at second coordinates is predicted to have an undesired structural status. Accordingly, the second coordinates indicated in the report can be used to locate the second grape that is predicted to have the undesired structural status, such that a worker can inspect the second grape and/or surrounding grapes to identify, and/or prevent the spread of, an infection, pests, and/or other reasons for the predate undesired structural status of the second grape.

Although FIG. 1 shows the object scanning system 100 scanning a single object, the object scanning system 100 can be used to scan multiple objects in an environment. As an example, as discussed above, an autonomous or human-movable instance of the scanning device 106 can move around an environment near different objects, such that the scanning device can output instances of the stimulus agent 112 toward the different objects and capture sensor data 114 indicating reactions of the different objects to the stimulus agent 112. As another example, a fixed instance of the scanning device 106 can be mounted above or beside a conveyor belt, such that the scanning device 106 can scan different objects as the objects are transported past the scanning device 106. The object model 116 can use the captured sensor data 114 to predict structural statuses of the different objects as discussed above. For example, as discussed above, the scanning device 106 can scan different objects in a defined sequence based on grid pattern or other pattern, in a random order or based on a randomly-selected subset of the overall number of objects, and/or based on any other selection technique.

Accordingly, the object scanning system 100 can reduce the time and effort to determine structural statuses of individual objects and/or sets of Objects. For instance, a drone or other autonomous instance of the scanning device 106 can be tasked to fly through vineyard or other environment to automatically scan selected objects, such that the object model 116 can use corresponding sensor data 114 to automatically predict structural statuses of the individual objects. Based on sensor data 114 captured by such a drone, the object scanning system 100 may be able to determine structural statuses of more objects than a human inspector could determine in a similar period of time.

Moreover, reactions of objects indicated by the sensor data 114 can indicate internal structural issues with objects that may be difficult or impossible for human observers to detect visually from the exterior of the objects. Accordingly, the structural statuses of individual objects predicted by the object model 116 may indicate such internal structural issues with objects earlier than the issues would be detected by human observers. Such early detection can limit and/or avoid wasted food, distribution of damaged products, continued deterioration of object structures, and/or other issues. For instance, if powdery mildew is infecting grapes at an area of a vineyard, structural statuses of grapes predicted by the object model 116 can indicate the infection before a human observer might otherwise detect the infection. Based on such early detection of the infection, the infected grapes can be discarded in order to avoid providing the infected grapes to consumers and/or to avoid the infection spreading to other areas of the vineyard.

FIG. 2 shows an example 200 of a mobile instance of the scanning device 106. In example 200, the mobile instance of the scanning device 106 can be an aerial drone or other aerial device that has rotors 202, wings, motors, and/or other elements that allow the aerial device to hover, fly, and/or otherwise maneuver through the air. In other examples, a mobile instance of the scanning device 106 may have wheels, treads, other propulsion elements, and/or other elements that allow the scanning device 106 to maneuver across a ground surface, through a water environment, and/or through any other environment.

As shown in FIG. 2, the mobile instance of the scanning device 106 can have the stimulus source 108 that is configured to output the stimulus agent 112. The mobile instance of the scanning device 106 can also have sensors 110, such as sensor 110A and sensor 1101, configured to capture sensor data 114 associated with reactions of objects to the stimulus agent 112. The mobile instance of the scanning device 106 can use rotors 202 and/or other elements to move to positions near different objects, such as objects 104A-104H shown in FIG. 2, at different times, and output the stimulus agent 112 towards different objects 104 and use sensors 110 to capture sensor data 114 indicating reactions of the different objects to the stimulus agent 112. Accordingly, the object model 116 can predict structural statuses of the different objects based on the captured sensor data 114. As discussed above, the scanning manager 118 can log geospatial coordinates indicating the position of each object and/or the position of the scanning device 106 when each object is scanned, such that structural statuses generated by the object model 116 based on the captured sensor data 114 can be associated with the corresponding objects.

In some examples, a mobile instance of the scanning device 106 can be configured to move autonomously, for instance to automatically identify and move to objects to be scanned. In other examples, a mobile instance of the scanning device 106 can be configured to move semi-autonomously or based on user input, for instance based remote control instructions provided by a human operator.

A mobile instance of the scanning device 106 can be deployed to move around an environment, and to scan one or more objects within the environment. For example, a mobile instance of the scanning device 106 can be deployed to scan produce on a farm, scan components of a building or other structure that may be difficult for humans to reach, and/or otherwise scan one or more objects in an environment.

FIG. 3 shows an example 300 of a handheld instance of the scanning device 106. In example 300, the handheld instance of the scanning device 106 can have a size, shape, and weight that allows a user to hold and move the scanning device 106. In some examples, the scanning device 106 can be an attachment that can be connected to a mobile phone, a tablet computer, a laptop computer, or another mobile computing device. In other examples, the scanning device 106 can be a standalone handheld device.

As shown in FIG. 3, the handheld instance of the scanning device 106 can have the stimulus source 108 that is configured to output the stimulus agent 112. The handheld instance of the scanning device 106 can also have sensors 110, such as sensor 110A and sensor 110B, configured to capture sensor data 114 associated with reactions of objects to the stimulus agent 112. A user can accordingly move the handheld instance of the scanning device 106 to positions near different objects, such as objects 104A-104H shown in FIG. 3, at different times, such that the scanning device 106 can output the stimulus agent 112 towards different objects 104 and use sensors 110 to capture sensor data 114 indicating reactions of the different objects to the stimulus agent 112. Accordingly, the object model 116 can predict structural statuses of the different objects based on the captured sensor data 114. As discussed above, the scanning manager 118 can log geospatial coordinates indicating the position of each object and/or the position of the scanning device 106 when each object is scanned, such that structural statuses generated by the object model 116 based on the captured sensor data 114 can be associated with the corresponding objects.

The handheld instance of the scanning device 106 can have a screen 302, lights, speakers, and/or other input and/or output elements. In some examples, the screen 302 may display a user interface that the user can view and/or interact with via the screen, such as a touchscreen, or other input elements. The user interface or other input elements may provide user-selectable controls that a user can select to initiate an output of the stimulus agent 112 towards an object, as well as corresponding capture of sensor data 114 indicating the reaction of the object to the stimulus agent 112. In some examples, the user interface or other output elements can present suggestions for a user to move the handheld instance of the scanning device 106 in one or more directions to bring the scanning device 106 to a position that is a target distance away from an object to be scanned, and/or present structural statuses of scanned objects predicted by the object model 116.

A handheld instance of the scanning device 106 can be used by a user to scan one or more objects within an environment at which the user is located. For example, a handheld instance of the scanning device 106 can be used by a farm worker to scan produce at a farm that is still growing or that has been harvested, or can be used by a grocery store worker to scan produce that is for sale or is to be stocked at a grocery store.

FIG. 4 shows an example 400 of a stationary instance of the scanning device 106. In example 400, the stationary instance of the scanning device 106 can be mounted at a fixed position within an environment, such that objects can be manually or automatically moved to and/or past the scanning device 106, For instance, as shown in FIG. 4, the scanning device 106 can be mounted above a conveyer belt 402 that transports objects, such as object 104A, object 104B, and object 104C, underneath the scanning device 106.

As shown in FIG. 4, the stationary instance of the scanning device 106 can have the stimulus source 108 that is configured to output the stimulus agent 112. The stationary instance of the scanning device 106 can also have sensors 110, such as sensor 110A and sensor 110B, configured to capture sensor data 114 associated with reactions of objects to the stimulus agent 112. When different objects, such as object 104A, object 104B, or object 104C, are positioned underneath the stationary instance of the scanning device 106 at different times by the conveyor belt 402, by users, or by other mechanisms, the scanning device 106 can output the stimulus agent 112 towards the different objects 104 and use sensors 110 to capture sensor data 114 indicating reactions of the different objects to the stimulus agent 112. Accordingly, the object model 116 can predict structural statuses of the different objects based on the captured sensor data 114.

A stationary instance of the scanning device 106 can be used in a factory, warehouse, or other environment to scan one or more objects being moved or transported through the environment. For example, the conveyer belt 402 may transport pieces of harvested produce through a warehouse towards packaging or shipping containers, and the stationary instance of the scanning device 106 can scan the objects so that individual objects likely to have undesired structural statuses can be identified and prevented from being packaged and/or shipped from the warehouse.

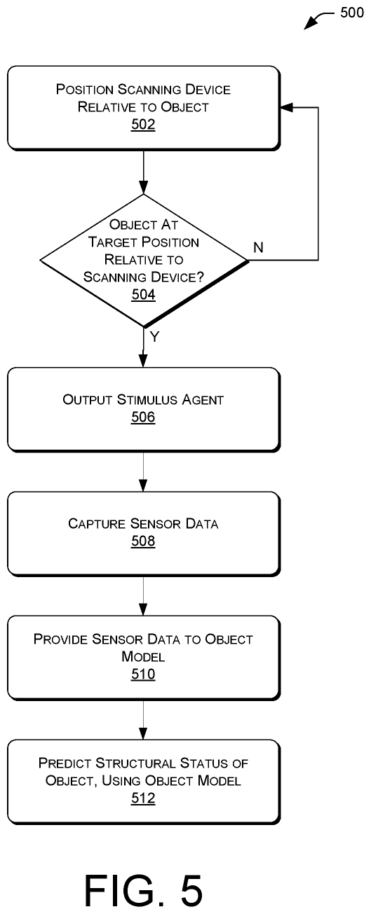

FIG. 5 is a flow diagram of an illustrative process 500 by which the object scanning system 100 can predict the structural status 102 of the object 104. Process 500 is illustrated as a collection of blocks in a logical flow graph, which represent a sequence of operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes.

At block 502, the scanning device 106 of the object scanning system 100 can be positioned relative to the object 104. In some examples, the object 104 can be in a fixed position, and the scanning device 106 can move autonomously, move based on user input, or be moved by a user, relative to the fixed position of the object 104. In other examples, the scanning device 106 can be in a fixed position, and the object 104 can be moved relative to the fixed position of the scanning device 106.

At block 504, the scanning manager 118 of the scanning device 106 can determine whether the object 104 is at target position relative to the scanning device 106. For example, the scanning device 106 can use sensor data 114 captured by laser distance sensor of the scanning device 106, or another distance or proximity sensor, to determine if the scanning device 106 is a target distance away from the object 104.

If the object 104 is not at the target position relative to the scanning device 106 (Block 504—No), the scanning device 106 can continue to be positioned relative to the object 104 at block 502 until the object 104 is at the target position relative to the scanning device 106. For example, if the scanning device 106 is a drone or other autonomous mobile device, propulsion and/or guidance systems of the scanning device 106 can cause the scanning device 106 to move in one or more directions until the object 104 is at the target position relative to the scanning device 106. As another example, if the scanning device 106 is a handheld device operated by a user, a user interface of the handheld device may provide suggestions to the user to move the scanning device 106 to move in one or more directions until the object 104 is at the target position relative to the scanning device 106.

If the object 104 is at the target position relative to the scanning device 106 (Block 504—Yes), the scanning manager 118 of the scanning device 106 can cause the stimulus source 108 to output the stimulus agent 112 towards the object 104 at block 506. In some examples, the scanning manager 118 can automatically cause the stimulus source 108 to output the stimulus agent 112 towards the object 104 based on determining at block 504 that the object 104 is at the target position relative to the scanning device 106. In other examples, the scanning manager 118 can enable a user interface element or other user-selectable control element based on determining at block 504 that the object 104 is at the target position relative to the scanning device 106, and the scanning manager 118 can cause the stimulus source 108 to output the stimulus agent 112 towards the object 104 if a user selects that user interface element or other user-selectable control element.

When the stimulus source 108 outputs the stimulus agent 112 towards the object 104, at block 508 the scanning manager 118 can cause sensors 110 of the scanning device 106 to capture sensor data. 114 indicating the reaction of the object 104 to the stimulus agent 112. For example, sensor 110A and sensor 110B can capture a series of stereoscopic images that indicate the reaction of the object 104 to the stimulus agent 112, such that disparities between the stereoscopic images can indicate traces of vibrations, wave movements, and/or other movements of one or more portions of the object 104 in response to impact of the stimulus agent 112 on the object 104.

At block 510, the scanning manager 118 can provide the sensor data 114 captured at block 508, which can indicate the reaction of the object 104 to the stimulus agent 112, to the object model 116. In some examples, the object model 116 can execute locally at the scanning device 106, such that the scanning manager 118 can cause the captured sensor data 114 to be stored in a local memory location accessible to the local object model 116 or to be otherwise provided to the local object model 116. In other examples, the object model 116 can execute remotely from the scanning device 106, for instance in a cloud computing environment, via one or more edge computing devices, or via one or more other computing devices separate from the scanning device 106. In these examples, the scanning manager 118 can use wired and/or wireless data transmission interfaces to send the captured sensor data 114 to the remotely-executing object model 116, for instance via a network.

At block 512, after the object model 116 receives the sensor data 114 sent at block 510, the object model 116 can use the sensor data 114 to predict the structural status 102 of the object 104. As described above, the object model 116 can have been trained to determine features of sample instances of sensor data 114, in the training data set 124, that are predictive of reactions of objects with desired structural statuses and/or reactions of the objects with undesired structural statuses. For instance, patterns, movements, disparities, and/or other features of sensor data 114 that indicates reactions of objects to the stimulus agent 112 can be determined, during training of the object model 116, to be predictive of the structural statuses of those Objects. Accordingly, the trained object model 116 can predict whether the object 104 has a desired structural status or an undesired structural status based on such features indicated in the sensor data 114 captured at block 508 and provided to the object model 116 at block 510.

In some examples, the object model 116 can store and/or output a report indicating the structural status 102 predicted at block 510. In other examples, the object model 116 can provide an indication of the structural status 102 predicted at block 510 to the scanning manager 118 and/or other elements of the scanning device 106, such the predicted structural status 102 of the object 104 can be displayed or otherwise presented via a screen and/or other output elements of the scanning device 106.

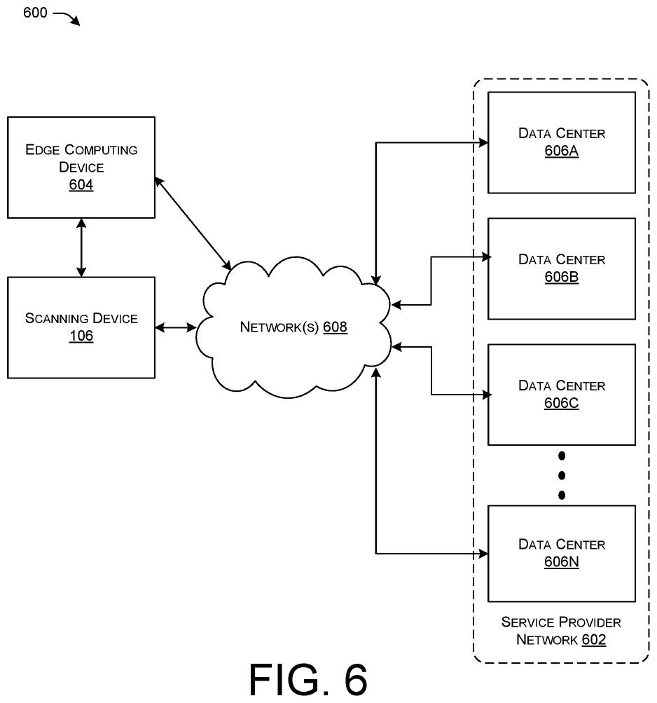

FIG. 6 is a system and network diagram that shows an illustrative operating environment 600 for configurations disclosed herein, which includes a service provider network 602 that can be configured to perform techniques disclosed herein. In some examples, the service provider network 602 can be a cloud computing environment, as described above. The scanning device 106 may send data to, and/or receive data from, the service provider network 602 as described herein. As shown in FIG. 6, in some examples, an edge computing device 604 may also be in data communication with the scanning device 106 and/or the service provider network 602.

Elements of the service provider network 602 can execute various types of computing and network services, such as data storage and data processing, and/or provide computing resources for various types of systems on a permanent or an as-needed basis. For example, among other types of functionality, the computing resources provided by the service provider network 602 may be utilized to implement various services described above such as, for example, services provided and/or used by the object model 116 and/or other elements described herein. Additionally, the operating environment can provide computing resources that include, without limitation, data storage resources, data processing resources, such as virtual machine (VM) instances, containers, networking resources, data communication resources, network services, and other types of resources.

Each type of computing resource provided by the service provider network 602 can be general-purpose or can be available in a number of specific configurations. For example, data processing resources can be available as physical computers, containers, or VM instances in a number of different configurations. The VM instances and/or containers can be configured to execute applications, including web servers, application servers, media servers, database servers, some or all of the network services described above, and/or other types of programs. Data storage resources can include file storage devices, block storage devices, and the like. The service provider network 602 can also be configured to provide other types of computing resources not mentioned specifically herein.

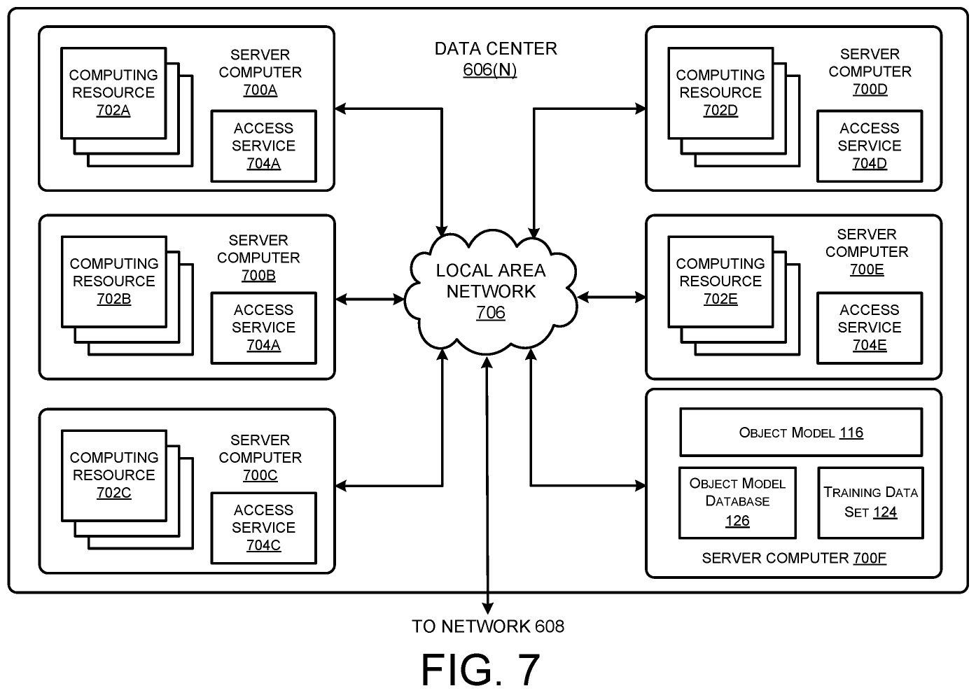

The computing resources provided by the service provider network 602 may be enabled in one embodiment by one or more data centers 606A-606N (which might be referred to herein singularly as “a data center 606” or in the plural as “the data centers 606”). The data centers 606 are facilities utilized to house and operate computer systems and associated components. The data centers 606 typically include redundant and backup power, communications, cooling, and security systems. The data centers 606 can also be located in geographically disparate locations. One illustrative embodiment for a data center 606 that can be utilized to implement the technologies disclosed herein will be described below with regard to FIG. 7.

The data centers 606 may be configured in different arrangements depending on the service provider network 602. For example, one or more data centers 606 may be included in, or otherwise make-up, an availability zone. Further, one or more availability zones may make-up or be included in a region. Thus, the service provider network 602 may comprise one or more availability zones, one or more regions, and so forth. The regions may be based on geographic areas, such as being located within a predetermined geographic perimeter.

Users and/or owners of the service provider network 602 may access the computing resources provided by the service provider network 602 over any wired and/or wireless network(s) 608, which can be a wide area communication network (“WAN”), such as the Internet, an intranet or an Internet service provider (“ISP”) network or a combination of such networks. As an example, and without limitation, the scanning device 106 can send data to, and/or receive data from, an instance of the object model 116 that executes within the service provider network 602 by way of the network(s) 608. As another example, the object model 116 can be trained in the service provider network 602, and an instance of the trained object model 116 can be provided to the scanning device 106 and/or the edge computing device 604 via the network(s) 608. As yet another example, the scanning device 106 and the edge computing device 604 may exchange data via the network(s) 608. It should be appreciated that a local-area network (“LAN”), the Internet, or any other networking topology known in the art that connects the data centers 606 to remote customers and other users can be utilized. It should also be appreciated that combinations of such networks can also be utilized.

Each of the data centers 606 may include computing devices that include software, such as applications that receive and transmit data. The data centers 606 can also include databases, data stores, or other data repositories that store and/or provide data. For example, data centers 606 can store data associated with the object model 116, the training data set 124, other object models and/or training data sets, the object model database 126, reports of structural statuses of objects predicted by one or more object models, and/or other elements described herein.

FIG. 7 is a computing system diagram that illustrates one configuration for a data center 606(N) that can be utilized to implement the object model 116 and/or other elements of the object scanning system 100, as described above in FIGS. 1-5. The example data center 606(N) shown in FIG. 7 includes several server computers 700A-700E (collectively 700) for providing computing resources 702A-702E (collectively 702), respectively.

The server computers 700 can be standard tower, rack-mount, or blade server computers configured appropriately for providing the various computing resources (illustrated in FIG. 7 as the computing resources 702A-702E). The computing resources 702 can include, without limitation, analytics applications, data storage resources, data processing resources such as VM instances or hardware computing systems, database resources, networking resources, and others. Some of the servers 700 can also be configured to execute access services 704A-704E (collectively 704) capable of instantiating, providing and/or managing the computing resources 702, some of which are described in detail herein.

The data center 606(N) shown in FIG. 7 also includes a server computer 700F that can execute at least some of the software components described above. For example, and without limitation, the server computer 700F can be configured to execute the object model 116, train the object model 116 based on the training data set 124, store the object model database 126, and/or perform other operations described herein. The server computer 700F can also be configured to execute other components and/or to store data for providing some or all of the functionality described herein. In this regard, it should be appreciated that components of the object scanning system 100 described herein can execute on many other physical or virtual servers in the data centers 606 in various configurations. For example, computing resources 702 of one or more server computers 700 can be used to train the object model 116, while computing resources 702 of one or more other server computers 700 can be used to execute the object model 116 to process new sensor data 114 after training of the object model 116.

In the example data center 606(N) shown in FIG. 7, an appropriate LAN 706 is also utilized to interconnect the server computers 700A-700F, The LAN 706 is also connected to the network 608 illustrated in FIG. 6. It should be appreciated that the configuration of the network topology described herein has been greatly simplified and that many more computing systems, software components, networks, and networking devices can be utilized to interconnect the various computing systems disclosed herein and to provide functionalities described above.

Appropriate load balancing devices or other types of network infrastructure components can also be utilized for balancing a load between each of the data centers 606(1)-(N), between each of the server computers 700A-700F in each data center 606, and, potentially, between computing resources 702 in each of the data centers 606. It should be appreciated that the configuration of the data center 606 described with reference to FIG. 7 is merely illustrative and that other implementations can be utilized.

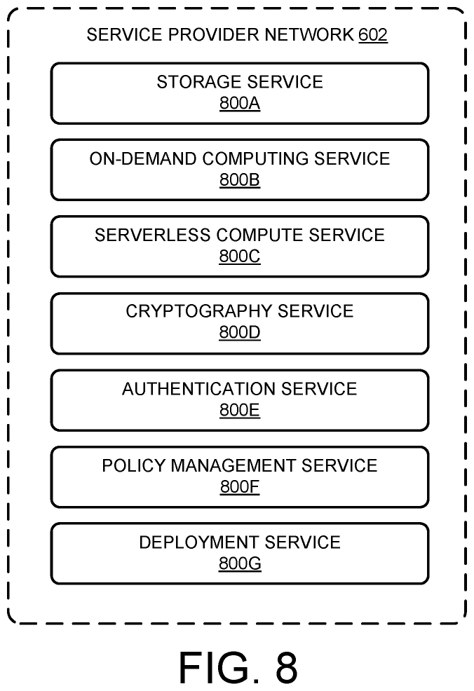

FIG. 8 is a system services diagram that shows aspects of several services that can be provided by and utilized within the service provider network 602, which can be configured to implement various technologies disclosed herein. The service provider network 602 can provide a variety of services to users and entities including, but not limited to, the object model 116, the object model database 126, a storage service 800A, an on-demand computing service 800B, a serverless compute service 800C, a cryptography service 8001), an authentication service 800E, a policy management service 800F, and a deployment service 800G. The service provider network 602 can also provide other types of computing services, some of which are described below.

It is also noted that not all configurations described include the services shown in FIG. 8 and that additional services can be provided in addition to, or as an alternative to, the services explicitly described herein. Each of the systems and services shown in FIG. 8 can also expose web service interfaces that enable a caller to submit appropriately configured. API calls to the various services through web service requests. The various web services can also expose GUIs, command line interfaces (“Ws”), and/or other types of interfaces for accessing the functionality that they provide. In addition, each of the services can include service interfaces that enable the services to access each other. Additional details regarding some of the services shown in FIG. 8 will now be provided.

The storage service 800A can be a network-based storage service that stores data obtained from users of the service provider network 602 and/or from computing resources in the service provider network 602. The data stored by the storage service 800A can be obtained from computing devices of users. The data stored by the storage service 800A may also include data associated with the object model 116 and/or other elements of the object scanning system 100, and/or other elements described herein.

The on-demand computing service 800B can be a collection of computing resources configured to instantiate VM instances and to provide other types of computing resources on demand. For example, a user of the service provider network 602 can interact with the on-demand computing service 800B (via appropriately configured and authenticated API calls, for example) to provision and operate VM instances that are instantiated on physical computing devices hosted and operated by the service provider network 602. The VM instances can be used for various purposes, such as to operate as servers supporting the network services described herein, a web site, to operate business applications or, generally, to serve as computing resources for the user.

Other applications for the VM instances can be to support database applications, electronic commerce applications, business applications and/or other applications. Although the on-demand computing service 800B is shown in FIG. 8, any other computer system or computer system service can be utilized in the service provider network 602 to implement the functionality disclosed herein, such as a computer system or computer system service that does not employ virtualization and instead provisions computing resources on dedicated or shared computers/servers and/or other physical devices.

The serverless compute service 800C is a network service that allows users to execute code (which might be referred to herein as a “function”) without provisioning or managing server computers in the service provider network 802. Rather, the serverless compute service 800C can automatically run code in response to the occurrence of events. The code that is executed can be stored by the storage service 800A or in another network accessible location.

In this regard, it is to be appreciated that the term “serverless compute service” as used herein is not intended to infer that servers are not utilized to execute the program code, but rather that the serverless compute service 8000 enables code to be executed without requiring a user to provision or manage server computers. The serverless compute service 800C executes program code only when needed, and only utilizes the resources necessary to execute the code. In some configurations, the user or entity requesting execution of the code might be charged only for the amount of time required for each execution of their program code.

The service provider network 602 can also include a cryptography service 800D. The cryptography service 800D can utilize storage services of the service provider network 602, such as the storage service 800A, to store encryption keys in encrypted form, whereby the keys can be usable to decrypt user keys accessible only to particular devices of the cryptography service 800D, The cryptography service 800D can also provide other types of functionality not specifically mentioned herein.

The service provider network 602, in various configurations, also includes an authentication service 800E and a policy management service 800F. The authentication service 800E, in one example, is a computer system (i.e., collection of computing resources) configured to perform operations involved in authentication of users or customers. For instance, one of the services shown in FIG. 8 can provide information from a user or customer to the authentication service 800E to receive information in return that indicates whether or not the requests submitted by the user or the customer are authentic.

The policy management service 800F, in one example, is a network service configured to manage policies on behalf of users or customers of the service provider network 602. The policy management service 800F can include an interface (e.g., API or GUI) that enables customers to submit requests related to the management of a policy, such as a security policy. Such requests can, for instance, be requests to add, delete, change, or otherwise modify policy for a customer, service, or system, or for other administrative actions, such as providing an inventory of existing policies and the like.

The service provider network 602 can additionally maintain other network services based, at least in part, on the needs of its customers. For instance, the service provider network 602 can maintain a deployment service 800G for deploying program code in some configurations. The deployment service 800G provides functionality for deploying program code, such as to virtual or physical hosts provided by the on-demand computing service 800B. Other services include, but are not limited to, database services, object-level archival data storage services, and services that manage, monitor, interact with, or support other services. The service provider network 602 can also be configured with other network services not specifically mentioned herein in other configurations.

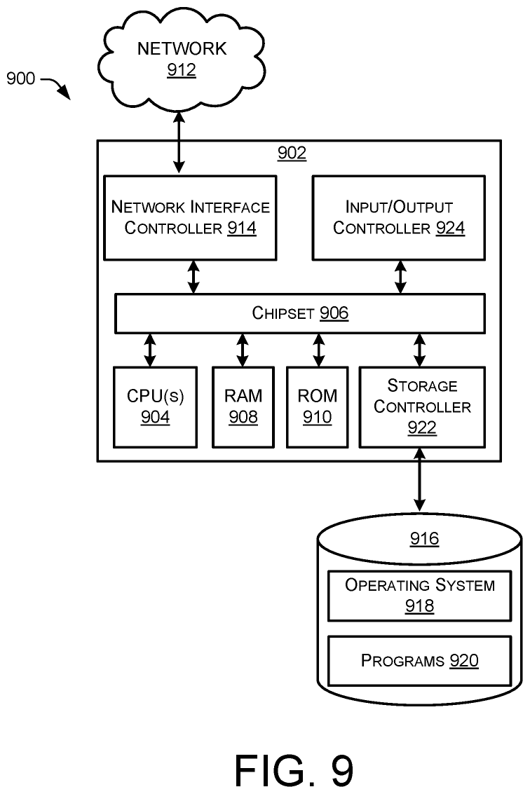

FIG. 9 shows an example computer architecture for a computer 900 capable of executing program components for implementing functionality described above. The computer architecture shown in FIG. 9 can be used in a conventional server computer, workstation, desktop computer, laptop, tablet, network appliance, e-reader, smartphone, or other computing device, and can be utilized to execute any of the software components presented herein. In some examples, the scanning device 106 can be or include the computer 900 with the computer architecture shown in FIG. 9, such that the scanning manager 118, a local instance of the object model 116, and/or other program components executed locally at the scanning device 106 can execute via the computer architecture shown in FIG. 9. In other examples, the computer 900 can be remote from the scanning device 106, and can train the object model 116, execute a remote instance of the object model 116, and/or execute other program components associated with the object scanning system 100 described herein. For instance, the computer 900 can be the edge computing device 604, a server 700 of the server provider network 602 or another computing environment, or any other computing device.

The computer 900 includes a baseboard 902, or “motherboard,” which may be one or more printed circuit boards to which a multitude of components and/or devices may be connected by way of a system bus and/or other electrical communication paths. In one illustrative configuration, one or more central processing units (“CPUs”) 904 operate in conjunction with a chipset 906. The CPUs 904 can be standard programmable processors that perform arithmetic and logical operations necessary for the operation of the computer 900.

The CPUs 904 perform operations by transitioning from one discrete, physical state to the next through the manipulation of switching elements that differentiate between and change these states. Switching elements can generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 906 provides an interface between the CPUs 904 and the remainder of the components and devices on the baseboard 902. The chipset 906 can provide an interface to a RAM 908, used as the main memory in the computer 900. The chipset 906 can further provide an interface to a computer-readable storage medium such as a read-only memory (“ROM”) 910 or non-volatile RAM (“NVRAM”) for storing basic routines that help to startup the computer 900 and to transfer information between the various components and devices. The ROM 910 or NVRAM can also store other software components necessary for the operation of the computer 900 in accordance with the configurations described herein.

The computer 900 can operate in a networked environment using logical connections to remote computing devices and computer systems through a network, such as the network 912. The chipset 906 can include functionality for providing network connectivity through a NIC 914, such as a gigabit Ethernet adapter. The NEC 914 is capable of connecting the computer 900 to other computing devices over the network 912. It should be appreciated that multiple NICs 914 can be present in the computer 900, connecting the computer to other types of networks and remote computer systems.

The computer 900 can be connected to a mass storage device 916 that provides non-volatile storage for the computer. The mass storage device 916 can store an operating system 918, programs 920, and data, which have been described in greater detail herein. The mass storage device 916 can be connected to the computer 900 through a storage controller 922 connected to the chipset 906. The mass storage device 916 can consist of one or more physical storage units. The storage controller 922 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 900 can store data on the mass storage device 916 by transforming the physical state of the physical storage units to reflect the information being stored. The specific transformation of physical state can depend on various factors, in different implementations of this description. Examples of such factors can include, but are not limited to, the technology used to implement the physical storage units, whether the mass storage device 916 is characterized as primary or secondary storage, and the like.

For example, the computer 900 can store information to the mass storage device 916 by issuing instructions through the storage controller 922 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 900 can further read information from the mass storage device 916 by detecting the physical states or characteristics of one or more particular locations within the physical storage units.

In addition to the mass storage device 916 described above, the computer 900 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 900.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned above, the mass storage device 916 can store an operating system 918 utilized to control the operation of the computer 900. According to one configuration, the operating system comprises the LINUX operating system or one of its variants such as, but not limited to, UBUNTU, DEBIAN, and CENTOS. According to another configuration, the operating system comprises the WINDOWS SERVER operating system from MICROSOFT Corporation. According to further configurations, the operating system can comprise the UNIX operating system or one of its variants. It should be appreciated that other operating systems can also be utilized. The mass storage device 916 can store other system or application programs and data utilized by the computer 900.

In one configuration, the mass storage device 916 or other computer-readable storage media is encoded with computer-executable instructions which, when loaded into the computer 900, transform the computer from a general-purpose computing system into a special-purpose computer capable of implementing the configurations described herein. These computer-executable instructions transform the computer 900 by specifying how the CPUs 904 transition between states, as described above. According to one configuration, the computer 900 has access to computer-readable storage media storing computer-executable instructions which, when executed by the computer 900, perform the various processes described above. The computer 900 can also include computer-readable storage media for performing any of the other computer-implemented operations described herein.

The computer 900 can also include one or more input/output controllers 924 for receiving and processing input from a number of input devices, such as a keyboard, a mouse, a touchpad, a touch screen, an electronic stylus, or other type of input device. Similarly, an input/output controller 924 can provide output to a display, such as a computer monitor, a flat-panel display, a digital projector, a printer, or other type of output device. It wilt be appreciated that the computer 900 might not include all of the components shown in FIG. 9, can include other components that are not explicitly shown in FIG. 9, or can utilize an architecture completely different than that shown in FIG. 9.

Based on the foregoing, it should be appreciated that technologies for predicting the structural status of an object have been disclosed herein. Moreover, although the subject matter presented herein has been described in language specific to computer structural features, methodological acts, and computer readable media, it is to be understood that the invention defined in the appended claims is not necessarily limited to the specific features, acts, or media described herein. Rather, the specific features, acts, and media are disclosed as example forms of implementing the claims.

The subject matter described above is provided by way of illustration only and should not be construed as limiting. Furthermore, the claimed subject matter is not limited to implementations that solve any or all disadvantages noted in any part of this disclosure. Various modifications and changes can be made to the subject matter described herein without following the example configurations and applications illustrated and described, and without departing from the true spirit and scope of the present invention, which is set forth in the following claims.

What is claimed is:

1. A method comprising:
obtaining a training data set of sample stereoscopic images indicating reactions of sample objects to a predetermined amount of air impacting the sample objects;
labeling the training data set to indicate:
first reactions of first sample objects, known to have a desired structural status, to the predetermined amount of air; and
second reactions of second sample objects, known to have an undesired structural status, to the predetermined amount of air;
training an object model, via supervised machine learning, to identify predictive features in the training data set that are predictive of the desired structural status or the undesired structural status;
positioning a scanning device at a target position relative to an object, wherein the scanning device is an aerial drone comprising:
a stimulus source configured to output the predetermined amount of air; and
at least two cameras;
causing the predetermined amount of air to be output, from the stimulus source, towards the object based on the scanning device being at the target position relative to the object;
capturing, via the at least two cameras, stereoscopic images indicating a reaction of the object to the predetermined amount of air; and
predicting, by the object model, a structural status of the object based on instances of the predictive features indicated in the stereoscopic images.

2. The method of claim 1, wherein:
the object is a piece of produce,
the undesired structural status is indicative of spoiled produce, and
the structural status predicted by the object model indicates whether the piece of produce is likely to have the desired structural status or the undesired structural status.

3. The method of claim 1, wherein disparities between the stereoscopic images indicate the reaction of the object as vibrations or other movements caused at least in part by waves, induced by the predetermined amount of air impacting the object, propagating through an internal structure of the object.

4. The method of claim 3, wherein the first reactions of the first sample objects and the second reactions of the second sample Objects are associated with different vibrations or different other movements induced by the predetermined amount of air impacting the sample objects.

5. A method comprising:
obtaining a training data set of sample sensor data indicating reactions of sample objects to instances of a stimulus agent;
labeling the training data set to indicate:
first reactions of first sample objects, known to have a desired structural status, to the instances of the stimulus agent; and
second reactions of second sample objects, known to have an undesired structural status, to the instances of the stimulus agent;
training an object model, via supervised machine learning, and based at least in part on the training data set, to identify predictive features in the training data set that are predictive of the desired structural status or the undesired structural status;
causing the stimulus agent to be output, from a stimulus source of a scanning device, towards an object;
capturing, via one or more sensors of the scanning device, sensor data indicating a reaction of the object to the stimulus agent; and
predicting, by the object model, a structural status of the object based at least in part on one or more of the predictive features indicted in the sensor data.

6. The method of claim 5, wherein:
the reaction of the object comprises vibrations or other movements caused at least in part by waves, induced by the stimulus agent, propagating through an internal structure of the object, and
the first reactions of the first sample objects and the second reactions of the second sample objects are associated with different vibrations or different movements induced by the instances of the stimulus agent.

7. The method of claim 5, wherein:
the training data set is further labeled to indicate a plurality of reasons associated with the second sample objects having the undesired structural status,
the object model is trained, based at least in part on the training data set, to identify second predictive features that are predictive of the plurality of reasons associated with the second sample objects having the undesired structural status, and
the structural status, predicted by the object model based at least in part on the sensor data, indicates that the object is likely to have the undesired structural status and at least one reason associated with the undesired structural status.

8. The method of claim 5, wherein:
the one or more sensors are cameras,
the sensor data comprises stereoscopic images, and
the method further comprises determining disparities between the stereoscopic images that indicate the reaction of the object as vibrations or movements caused at least in part by waves, induced by an impact of the stimulus agent on an exterior of the object, propagating through an internal structure of the object.

9. The method of claim 5, further comprising selecting the object model from an object model database storing a plurality of different object models corresponding to different types or classifications of objects, based at least in part on a type or classification of the object.

10. The method of claim 9, further comprising:
using at least two object models, of the plurality of different object models, to predict at least two structural status predictions based at least in part on the sensor data in association with corresponding confidence levels; and
determining the type or classification of the object based at least in part on one structural status prediction, of the at least two structural status predictions, that is associated with a highest confidence level of the corresponding confidence levels.

11. The method of claim 5, further comprising:
positioning, at different times, the scanning device proximate to different objects in an environment;
causing the stimulus agent to be output, from the stimulus source, towards the different objects at the different times;
capturing, via the one or more sensors at the different times, different instances of the sensor data indicating reactions of the different objects to the stimulus agent; and
predicting, by the object model, structural statuses of the different objects based at least in part on the different instances of the sensor data.

12. The method of claim 11, further comprising selecting the different objects from a set of objects in the environment at random or based at least in part on a grid pattern within the environment.

13. The method of claim 5, wherein the object model executes locally on the scanning device to predict the structural status of the object, via one or more computing resources of the scanning device.

14. The method of claim 5, wherein:
the object model executes via one or more computing resources of a service provider network, and
the method further comprises sending the sensor data from the scanning device to the object model via at least one network.

15. The method of claim 5, wherein the object model executes, to predict the structural status of the object, via one or more edge computing devices associated with the scanning device.

16. A scanning device comprising:
a stimulus source configured to output a stimulus agent;
one or more sensors; and
a scanning manager configured to:
cause the stimulus agent to be output, from the stimulus source, towards an object;
cause the one or more sensors to capture sensor data indicating a reaction of the object to the stimulus agent; and
provide the sensor data to an object model configured to predict a structural status of the object based on the sensor data,
wherein the object model is a machine learning model trained to identify features, indicated in a training data set of sample sensor data, that are predictive of known desired structural statuses and known unknown structural statuses of sample objects, and
the object model is configured to predict the structural status of the object based at least in part on instances of the features indicated in the sensor data.

17. The scanning device of claim 16, wherein the scanning device is an autonomous or semi-autonomous mobile device configured to move automatically relative to the object.

18. The scanning device of claim 16, wherein:
the scanning device is a handheld device movable by a user relative to the object, and
the handheld device comprises at least one output element configured to present an indication of the structural status of the object predicted by the object model.

19. The scanning device of claim 16, wherein the scanning device is a stationary device configured to output the stimulus agent and capture the sensor data in response to the scanning manager identifying, based at least in part on distance information captured by the one or more sensors, that the object is in a target position relative to the stationary device.

20. The scanning device of claim 16, wherein:
the one or more sensors are cameras,
the sensor data comprises stereoscopic images, and
disparities between the stereoscopic images indicate the reaction of the object as vibrations or movements caused at least in part by waves, induced by an impact of the stimulus agent on an exterior of the object, propagating through an internal structure of the object.

21. The scanning device of claim 16, wherein:
the one or more sensors comprise are at least one of Light Detection and Ranging (LiDAR) sensors or interferometry sensors, and
the sensor data indicates changes to an exterior of the object over a period of time caused at least in part by waves, induced by an impact of the stimulus agent on the exterior of the object, propagating through an internal structure of the Object.
